(19) United States
(12) Patent Application Publication
(10) Pub. No.: US 2007/0240183 A1
(43) Pub. Date: Oct. 11, 2007

(54) METHODS, SYSTEMS, AND COMPUTER PROGRAM PRODUCTS FOR FACILITATING INTERACTIVE PROGRAMMING SERVICES

(75) Inventors: Zachary A. Garbow, Rochester, MN (US); Candace T. Pederson, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: International Business Machines Corporation, Armonk, NY (US)

(21) Appl. No.: 11/278,713

(22) Filed: Apr. 5, 2006

(51) Int. Cl. H04N 5/445

(52) U.S. Cl. 725/38

(57) ABSTRACT

A method, system, and computer program product for facilitating interactive programming services is provided. The method includes providing a selection of viewpoints for perceiving a program event. Each of the viewpoints provides a unique perspective of the program event. The viewpoints are simultaneously transmitted to a digital media system as a single programming event, which is one of a plurality of programming events that collectively form a program. The method also includes providing criteria selectable for determining which of the viewpoints to present via the digital media system, receiving at least one response to the criteria, and selecting a viewpoint to present based upon the at least one response. The method further includes presenting the program event, the program event exhibited from the selected viewpoint.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to interactive digital media systems, and particularly to methods, systems, and computer program products for facilitating interactive programming services.

2. Description of Background

One area within home entertainment that has received press as an emerging market is the future capabilities of interactive television. Integrating large video-processing power for advanced multiprocessing devices into television sets enables some desirable functions, allowing user controlled manipulation of multiple varying viewpoints (camera angles).

A user who is given an option of manually switching between multiple camera angles might likely feel overwhelmed, and as a result, may prefer to avoid using the function, rather than attempt to navigate among so many options.

What is needed, therefore, is a way to facilitate the selection and use of multiple programming viewpoints by automating switching among viewpoint sources based upon criteria such as user preferences (e.g., as configured via rules and via behavior analysis and tracking) and group and/or social paradigms established among a set of users.

### SUMMARY OF THE INVENTION

The shortcomings of the prior art are overcome and additional advantages are provided through the provision of methods, systems, and computer program products for facilitating interactive programming services. The method includes providing a selection of viewpoints for perceiving a program event. Each of the viewpoints provides a unique perspective of the program event. The viewpoints are simultaneously transmitted to a digital media system as a single programming event, which is one of a plurality of programming events that collectively form a program. The method also includes providing criteria selectable for determining which of the viewpoints to present via the digital media system, receiving at least one response to the criteria, and selecting a viewpoint to present based upon the at least one response. The method further includes presenting the program event, the program event exhibited from the selected viewpoint.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which facilitates the selection and use of multiple programming viewpoints by automating switching among viewpoint sources based upon criteria such as user preferences (e.g., as configured via rules and via behavior analysis and tracking) and group and/or social paradigms established among a set of users.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram upon which a system for implementing interactive programming services in exemplary embodiments;

FIG. 2 illustrates one example of a flow diagram describing a process for implementing individual rule-based automation features of the interactive programming services in exemplary embodiments;

FIG. 3 illustrates one example of a flow diagram describing a process for implementing rule-based group features of the interactive programming services in exemplary embodiments; and

FIG. 4 illustrates one example of a flow diagram describing a process for implementing rule-based automation features via behavioral analysis of the interactive programming services in exemplary embodiments.

The detailed description explains the preferred embodiments of the invention, together with advantages and features, by way of example with reference to the drawings.

### DETAILED DESCRIPTION OF THE INVENTION

In accordance with exemplary embodiments, interactive programming services are provided. Programming content delivered to a digital media system includes multiple viewpoints or perspectives of the content, which is selectable by a viewer and/or a viewing population. The interactive programming services enables a viewer and/or viewing population to select the display or presentation of preferred viewpoints of the content via an automated rule-based component of the services. The viewpoint selection may be generated via a user profile that includes rules and conditions for determining which viewpoint is presented. The interactive programming services also enable a user to become part of a larger user/viewer group, either a location-based group (that is defined by the group members) or a community group that is defined by the service provider of the interactive programming services.

A viewpoint refers to a portion of content or programming that provides a particular perspective of the content (e.g., a camera that records the content from a particular angle at a fixed location, a roving camera that follows a particular object or event, a camera that is fixed to a particular object or individual, etc.) A viewpoint may also refer to a measure of distance from an object or event that is part of the program. Thus, a viewpoint may be location based and/or object based. The content, including the multiple viewpoints, is transmitted to multiple receiving locations as described further herein.

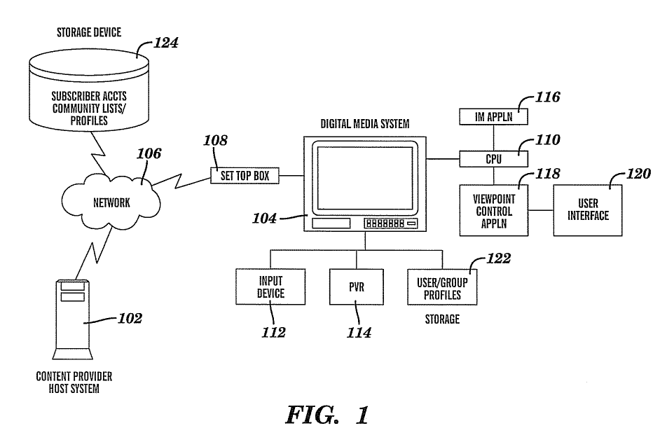

Turning now to FIG. 1, a system upon which the interactive programming services may be implemented in exemplary embodiments will now be described. The system of FIG. 1 includes a host system 102 in communication with a digital media system 104 via one or more networks 106 and a set top box 108.

Host system 102 may comprise any high-speed processing device, e.g., a mainframe computer that is capable of handling large volumes of processing activities. In exemplary embodiments, host system 102 is implemented by a digital content service provider that provides programming services to customers, such as a user of digital media system 104, for a fee. Content provided by the host system may include, e.g., television programming (such as sporting events, movies, pay-per-view programs, music, etc.). In addition, host system 102 may also provide multi-media communications services, such as Internet access, web browsing, email, instant messaging, video chat, interactive gaming, etc. Additionally, host system 102 facilitates the interactive programming services described herein.

Digital media system 104 refers to a device via which a user can receive content (e.g., programming). For example, digital media system 104 may be an Internet Protocol (IP)-enabled television (IPTV), a personal computer, or other similar type of device. The digital media system 104 is communicatively coupled to the set top box 108, which may include hardware and/or software for handling user requests to utilize various multi-media services via a broadband Internet connection. Network 106 may comprise a switched telephone or cable network.

In exemplary embodiments, digital media system 104 includes a central processing unit (CPU) 110, or processor, and an input device 112. In exemplary embodiments, CPU 110 comprises a micro-processor or advanced processing device for implementing the interactive programming services described herein. For example, CPU 110 may comprise a Cell multiprocessor that provides an advanced chip architecture design that uses high-speed broadband connectivity. The Cell multiprocessor is the result of a joint development project by Sony Computer Entertainment Inc., International Business Machines Corp., and Toshiba Corp. Input device 112 may comprise a remote control, a keyboard, mouse, buttons onboard the digital media system 104, etc.

CPU 110 executes one or more applications via the digital media system 104. Communications applications such as email (not shown) and instant messaging 116 may be implemented via CPU 110 and the digital media system 104. In addition, an application for implementing the interactive programming services may be executed by CPU 110. This application is referred to herein as a viewpoint control application 118. The viewpoint control application 118 includes a user interface 120, both of which will be described further herein.

Also shown in FIG. 1 is a personal video recorder (PVR) 114. PVR 114 refers to a device that is internal or external to the digital media system 104 and which records/plays back programs or other content on behalf of a user of the digital media system 104. For example, PVR 114 may record programs transmitted via the host system 102 and played back on the digital media system 104 at a later time.

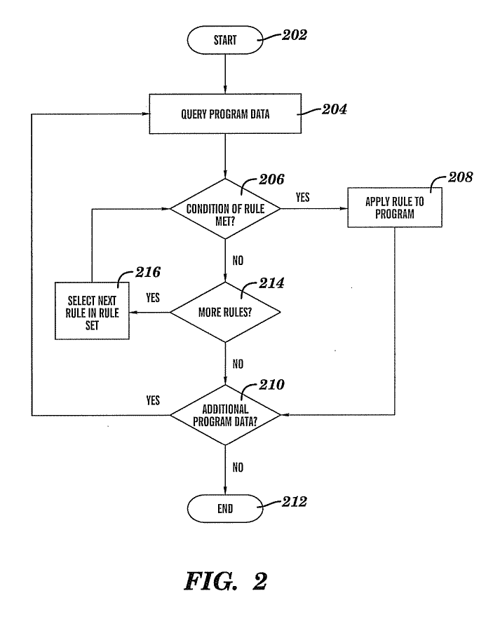

The digital media system 104 of FIG. 1 further includes storage 122 for housing information utilized by the viewpoint control application 118. Storage 122 may comprise internal memory (i.e., main memory) built into the digital media system 104 or may be external, or secondary storage, located outside of the digital media system 104. In exemplary embodiments, storage 122 houses user profiles and/or group profiles generated via the viewpoint control application 118. A user profile provides particular preferences supplied by a user of the digital media system 104 via the viewpoint control application 118. The user's individual preferences are stored in the user profile and are accessible via the viewpoint control application 118 for use in implementing the individual rule-based automation features, which are described further in FIG. 2.

Group preferences refer to the collective preferences of a group of users that may be viewing a particular program at a single location (e.g., user's home) or may be two or more users viewing a particular program at different locations but who wish to experience the program via the same viewpoints. For example, two users are each viewing a program from a different location and are also experiencing the program, e.g., via instant messaging, telephone, or other communication means. The group features of the viewpoint control application 118 are described further herein.

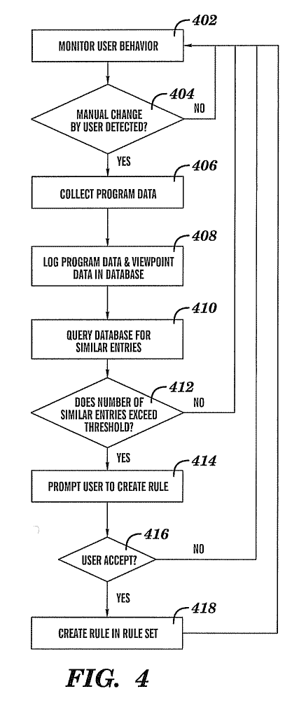

Storage 122 may also house information tracked by the viewpoint control application 118 that relates to user activities with respect to manual viewpoint switching (e.g., when a user physically selects a different viewpoint during a program). These behaviors are tracked and monitored by the viewpoint control application 118 in order to implement rule-based automation features via behavioral analysis, which is described further in FIG. 4.

The viewpoint control application 118 provides a user-configurable rule set to dictate or influence which viewpoint is used for particular situations. This is facilitated by the user profile. By way of example, suppose in a football game, each player's helmet is embedded with a camera. Suppose also that there are various sideline cameras, end zone cameras, and even a coach-cam. Each viewer may wish to watch the game from a different perspective during particular situations. The user may configure this rule set to specify which camera or viewpoint to use when particular criteria are met with the program. The user may configure one rule within the rule set to tell the system to use the normal sideline camera during most situations, but switch to the camera of the nearest wide receiver when a ball is thrown, and further, use the goalpost camera when the ball is within ten yards of the end zone. In another example, suppose a user watching an Academy Awards show prefers a front-row camera view during musical performances, but a more standard angle during awards announcements.

To aid in the rule-based functionality provided by the viewpoint control application 118, producers of programming may provide a priority list of camera angles and specify how these angles are ranked according to the level of their involvement with a particular programming event or artistic effect of the content. The top ranked viewpoint or angle may be specified as the default viewpoint, and the bottom ranked viewpoints may not even show the programming. This allows a user to specify exceptions to rules to prevent switching to a camera that is out of the top rankings. Other rules may utilize a preference or exclusion of a particular camera or viewpoint or a preference toward viewpoints that show a particular object or individual.

The programming event, as described herein, may be a segmented portion of the program and may be defined using various criteria. For example, a programming event for a basketball game may be a foul shot resulting from an earlier issued penalty. A first viewpoint of this programming event may be a close up of the shooting player, while a second viewpoint of the same event may be taken from above the backboard. A third viewpoint of the same programming event may be a side view of the shooting player taken from the sidelines of the basketball court that is closest to the hoop.

As indicated above, some of the preferences may be based upon an object or individual in view. For example, if a user is watching a reality show and is interesting in observing their favorite contestant, their rule may include choosing a camera angle that most frequently shows this contestant. This may be implemented via tags inserted, e.g., by the show's producers. Alternatively, the viewpoint control application 118 may analyze the video frames to determine which cameras include the character in question. This information may then be used by the rules to present to the user the viewpoint options that include the contestant and allow the user the ability to manually switch from a currently displayed viewpoint to an appropriate viewpoint in order to view the contestant. Additionally, by analyzing the video frames in recorded media (e.g., content stored on PVR 114 or hard drive), the viewpoint control application 118 would indicate to the user which viewpoint will contain the desired object or individual in a specified time period. The viewpoint control application 118 may include the ability to override the default viewpoint settings or proactively switch to a desired viewpoint in anticipation of an upcoming action.

Also shown in the system of FIG. 1 is a storage device 124. Storage device 124 stores information utilized by the host system 102 in furtherance of providing the interactive programming services. For example, storage device 124 stores subscriber accounts, community lists, and community profiles, each of which will be described further herein. As shown in FIG. 1, storage device 124 is in communication with host system 102 via network 106. However, it will be understood by those skilled in the art that the storage device 124 may be directly coupled to the host system 102 (e.g., via cabling or wireless means).

Turning now to FIG. 2, a flow diagram describing a process for implementing individual rule-based automation features of the interactive programming services in exemplary embodiments will now be described. The process begins at step 202 whereby the viewpoint control application 118 queries program data received at the digital media system 104 in light of a user-configured rule provided in the rule set stored in the user profile at step 204. Based upon the query, it is then determined whether a condition of the rule has been met at step 206. If so, the viewpoint control application 118 applies the rule to the program at step 208. For example, the user profile includes a rule that specifies some action if musical performance is scheduled to occur within the program. The condition specifies a desired viewpoint or camera angle for presenting the musical performance. Since the condition has been met (once the performance is set to commence), the viewpoint control application 118 switches to the desired viewpoint.

At step 210, it is then determined whether any additional program data remains for query (i.e., is there additional programming matter to be presented). If so, the process returns to step 204. Otherwise, the process ends at step 212.

Returning to step 206, if the condition of the rule has not been met, it is determined whether any other rules exist in the rule set at step 214. If so, the viewpoint control application 118 selects the next rule in the rule set and the process returns to step 206. If, on the other hand, there are no other rules in the rule set, the process proceeds to step 210 whereby the viewpoint control application 118 determines if any additional programming data remains for query. If so, the process returns to step 204. Otherwise, the process ends at step 212.

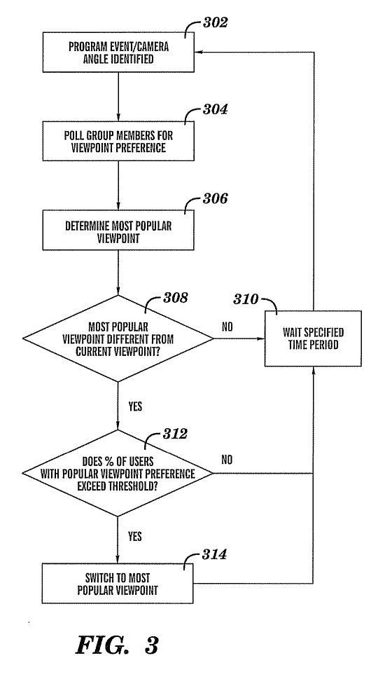

Turning now to FIG. 3, a flow diagram describing a process for implementing rule-based group features of the interactive programming services in exemplary embodiments will now be described. For purposes of illustration, assume that three individuals are present at a location where the digital media system 104 is situated, where a program has commenced. At step 302, a program event and various corresponding viewpoints associated with the event are identified by the viewpoint control application 118. The viewpoint control application 118 polls each group member for a viewpoint preference with respect to the available viewpoints at step 304. At step 306, the most popular viewpoint of the group members is determined as a result of the polling.

At step 308, it is determined whether the most popular viewpoint is different than that of the currently displayed or referenced viewpoint (e.g., are the two viewpoints originating from the same camera). If not, the viewpoint control application 118 waits a specified period of time at step 310 and the process returns to step 302. Thus, the viewpoint control application 118 maintains the current viewpoint for display. If, on the other hand, the two viewpoints are not the same, it is next determined whether a percentage of users sharing the popular viewpoint exceed a specified threshold at step 312. For example, a user may set a threshold that specifies what percentage of users are required to share the same popular viewpoint before the viewpoint control application 118 will switch to the popular viewpoint for display on the digital media system 104. If the threshold has not been met, the viewpoint control application 118 waits a specified period of time at step 310 and the process returns to step 302. If the percentage meets or exceeds a specified threshold, the viewpoint control application 118 causes the programming to switch to the most popular viewpoint at step 314. The viewpoint control application 118 waits a specified period of time at step 310 and the process returns again to step 302.

As indicated above, a community-based feature may be implemented by the interactive programming services. As some viewers may prefer more discrete manual or rule set-defined controls over which viewpoints to use under certain situations, other users may prefer an easier solution. Instead of relying on default viewpoints provided by the programming, the viewpoints presented may reflect the input of a larger community of users. For example, if 60% of users switched to camera B during a particular play during a sporting event, a user who is relying on community input may have his/her own viewpoint switched to the same camera if, e.g., a threshold value is met. The community-based features may be implemented via the viewpoint control application 118 and the host system 102, which receives these selections from users who wish to be included in a community group (e.g., the group of users viewing the sporting event). The user provides these preferences to the host system 102 via, e.g., the digital media system 104 using input device 112, viewpoint control application 118, and user interface 120, which provides user-selectable options that may be presented on a display element of the digital media system 104.

Turning now to FIG. 4, a flow diagram describing a process for implementing rule-based automation features via behavioral analysis of the interactive programming services in exemplary embodiments will now be described in accordance with exemplary embodiments. The rule-based automation features that utilize behavior analysis provide an intelligent solution for creating and/or modifying rules in a user's rule set. The processing provided in the flow diagram of FIG. 4 may supplement some or a portion of the activities performed in FIG. 2.

At step 402, the viewpoint control application 118 monitors user behavior with respect to program viewing and viewpoint selection. At step 404, it is determined whether a manual change of viewpoint has been initiated by a user. If not, the process returns to step 402. Otherwise, the viewpoint control application 118 collects program data at step 406 for the program events associated with the manual change in viewpoint selection. For example, if the program event involves a viewpoint change relating to a foul shot taken by a player during a basketball event, the program data surrounding the event (i.e., foul shot, player number, team, etc.) may be captured by the viewpoint control application 118. The program data and viewpoint data (i.e., the particular viewpoint selected by the user as a result of the manual change) are logged into a database at step 408. At step 410, the viewpoint control application 118 queries the database for similar entries.

At step 412, it is determined whether the number of similar entries exceeds a specified threshold. For example, the viewpoint control application 118 determines whether the history of user activity constitutes a pattern of activity that is sufficient to warrant further action. If not, the process returns to step 302. Otherwise, the user is prompted to create a new rule at step 414. For example, the new rule may specify that future program events that depict foul shots be presented from a particular viewpoint. At step 416, it is determined whether the user has accepted the invitation to create a new rule. If not, the process returns to step 402. Otherwise, the viewpoint control application 118 creates a new rule via the user's input at step 418.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A method for facilitating interactive programming services, comprising:
providing a selection of viewpoints for perceiving a program event, each of the viewpoints providing a unique perspective of the program event, the viewpoints simultaneously transmitted to a digital media system as a single programming event, the single programming event comprising one of a plurality of programming events that collectively form a program;
providing criteria selectable for determining which of the viewpoints to present via the digital media system;
receiving at least one response to the criteria and selecting a viewpoint to present based upon the at least one response; and
presenting the program event, the program event exhibited from the selected viewpoint.

2. The method of claim 1, wherein the criteria includes a rule that specifies a preferred viewpoint of the program event given the occurrence of a specified condition; wherein the viewpoints include:
a fixed camera angle;
a camera view displaying an object or individual; and
a view resulting from a camera embedded in object.

3. The method of claim 2, wherein the criteria includes a location-based user group preference and the determining which of the viewpoints to present includes polling a group of individuals at a location for individual viewpoint preferences, determining a most popular viewpoint based upon collective responses from the group, and selecting the most popular viewpoint for presentation.

4. The method of claim 3, further comprising determining whether a percentage of individuals sharing the most popular viewpoint exceed a specified threshold; wherein the selecting the most popular viewpoint for presentation is performed only if the percentage exceeds the specified threshold.

5. The method of claim 1, further comprising:
monitoring activities performed by an individual with respect to manual switching of viewpoints during execution of a program;
logging the activities in a database; and
upon detecting a manual switch of viewpoint:
comparing program event data surrounding the manual switch with program event data stored in the database;
prompting the individual to create a rule for specifying automatic switching of viewpoints in future program events when, based upon the comparing, a pattern of similar manual switching activities is detected; and
applying the rule to a user profile when the individual accepts the prompt to create the rule.

6. A system for facilitating interactive programming services, comprising:
a digital media system;
a viewpoint control application executing on the digital media system, performing:
providing a selection of viewpoints for perceiving a program event, each of the viewpoints providing a unique perspective of the program event, the viewpoints simultaneously received at the digital media system as a single programming event, the single programming event comprising one of a plurality of programming events that collectively form a program;
providing criteria selectable for determining which of the viewpoints to present via the digital media system;
receiving at least one response to the criteria and selecting a viewpoint to present based upon the at least one response; and
presenting the program event, the program event exhibited from the selected viewpoint.

7. The system of claim 6, wherein the criteria includes a rule that specifies a preferred viewpoint of the program event given the occurrence of a specified condition; wherein the viewpoints include:
a fixed camera angle;
a camera view displaying an object or individual; and
a view resulting from a camera embedded in object.

8. The system of claim 7, wherein the criteria includes a location-based user group preference and the determining which of the viewpoints to present includes polling a group of individuals at a location for individual viewpoint preferences, determining a most popular viewpoint based upon collective responses from the group, and selecting the most popular viewpoint for presentation.

9. The system of claim 8, wherein the viewpoint control application further performs:
determining whether a percentage of individuals sharing the most popular viewpoint exceed a specified threshold; wherein the selecting the most popular viewpoint for presentation is performed only if the percentage exceeds the specified threshold.

10. The system of claim 6, wherein the viewpoint control application further performs:
monitoring activities performed by an individual with respect to manual switching of viewpoints during execution of a program;
logging the activities in a database; and
upon detecting a manual switch of viewpoint:
comparing program event data surrounding the manual switch with program event data stored in the database;
prompting the individual to create a rule for specifying automatic switching of viewpoints in future program events when, based upon the comparing, a pattern of similar manual switching activities is detected; and
applying the rule to a user profile when the individual accepts the prompt to create the rule.

11. A computer program product for facilitating interactive programming services, the computer program product including instructions for implementing a method, comprising:
providing a selection of viewpoints for perceiving a program event, each of the viewpoints providing a unique perspective of the program event, the viewpoints simultaneously transmitted to a digital media system as a single programming event, the single programming event comprising one of a plurality of programming events that collectively form a program;
providing criteria selectable for determining which of the viewpoints to present via the digital media system;
receiving at least one response to the criteria and selecting a viewpoint to present based upon the at least one response; and
presenting the program event, the program event exhibited from the selected viewpoint.

12. The computer program product of claim 11, wherein the criteria includes a rule that specifies a preferred viewpoint of the program event given the occurrence of a specified condition; wherein the viewpoints include:
a fixed camera angle;
a camera view displaying an object or individual; and
a view resulting from a camera embedded in object.

13. The computer program product of claim 12, wherein the criteria includes a location-based user group preference and the determining which of the viewpoints to present includes polling a group of individuals at a location for individual viewpoint preferences, determining a most popular viewpoint based upon collective responses from the group, and selecting the most popular viewpoint for presentation.

14. The computer program product of claim 13, further comprising instructions for implementing:
determining whether a percentage of individuals sharing the most popular viewpoint exceed a specified threshold; wherein the selecting the most popular viewpoint for presentation is performed only if the percentage exceeds the specified threshold.

15. The computer program product of claim 1, further comprising instructions for implementing:
monitoring activities performed by an individual with respect to manual switching of viewpoints during execution of a program;
logging the activities in a database; and
upon detecting a manual switch of viewpoint:
comparing program event data surrounding the manual switch with program event data stored in the database;
prompting the individual to create a rule for specifying automatic switching of viewpoints in future program events when, based upon the comparing, a pattern of similar manual switching activities is detected; and
applying the rule to a user profile when the individual accepts the prompt to create the rule.
